(19) United States
(12) Patent Application Publication
(10) Pub. No.: US 2012/0008685 A1
(43) Pub. Date: Jan. 12, 2012

(54) IMAGE CODING DEVICE AND IMAGE CODING METHOD

(75) Inventors: Yoshimitsu SASAKI, Kyoto (JP); Shinji KITAMURA, Kyoto (JP); Yasuharu TANAKA, Osaka (JP)

(73) Assignee: PANASONIC CORPORATION, Osaka (JP)

(21) Appl. No.: 13/234,754

(22) Filed: Sep. 16, 2011

Related U.S. Application Data
(63) Continuation of application No. PCT/JP2009/006718, filed on Dec. 9, 2009.

(30) Foreign Application Priority Data
Mar. 25, 2009 (JP) 2009-075160

(51) Int. Cl. H04N 7/32

(52) U.S. Cl. 375/240.13; 375/E07.243

(57) ABSTRACT

A reference picture selection unit compares a predicted inter-coding amount indicating a predicted amount of coding required to perform inter prediction on a coding-target field and a predicted intra-coding amount indicating a predicted amount of coding required to perform intra prediction on the coding-target field. Upon determining that the predicted inter-coding amount is relatively larger than the predicted intra-coding amount, the reference picture selection unit switches the reference picture from a field having the same parity as the coding-target field to a field which is referable and temporally closest to the coding-target field.

### CROSS REFERENCE TO RELATED APPLICATION

This is a continuation application of PCT application No. PCT/JP2009/006718 filed on Dec. 9, 2009, designating the United States of America.

### BACKGROUND OF THE INVENTION

(1) Field of the Invention

The present invention relates to a reference picture determination method used when interlaced coding is performed in video signal compression. In particular, the present invention provides a method of selecting a reference picture according to a predicted intra-coding amount and a predicted inter-coding amount to reduce the number of times data stored in a memory is accessed.

(2) Description of the Related Art

In general, data compression in video coding is performed to reduce the quantity of data by reducing spatio-temporal redundancy in a video signal. In inter predictive coding executed for the purpose of reducing the temporal redundancy, motion estimation is performed on a coding-target picture on a block by block basis using, as a reference picture, a preceding or following picture to generate a predicted picture, and then a difference value between the predicted picture and the coding-target picture is coded. Here, the term “picture” is used to indicate one screen of image, and refers to a frame in the case of progressive image and to a frame or field in the case of interlaced image. The “interlaced image” refers to an image where one frame includes two fields shot at two different times, each of the two fields spatially being positioned on every other line so that the two fields alternate on the frame.

FIG. 11 shows an interlaced image. Of the two fields, one field made up of top lines of the image is referred to as a top field and the other field made up of bottom lines of the image is referred to as a bottom field. When there are two fields which are both top fields or both bottom fields, these two fields are referred to as the same-parity fields. Moreover, when there are two fields which are top and bottom fields, these two fields are referred to as the opposite-parity fields.

The H.264 standard recommended by the International Telecommunication Union Telecommunication Standardization Sector (ITU-T) defines the picture types as follows. An “I-picture” refers to a picture which does not have a reference picture and is obtained by intra predictive coding performed using an image present in the same picture as a coding-target image. A “P-picture” refers to a picture which is obtained by inter predictive coding performed using only one preceding or following picture as a reference picture. A “B-picture” refers to a picture which is obtained by inter predictive coding performed using two reference pictures at the same time. As compared with the conventional Moving Picture Expert Group-2 (MPEG-2), the H.264 standard provides more prediction methods and thus improves the coding accuracy. However, the amount of calculation required for prediction is increased and more memory is needed to store reference pictures to be used for the prediction.

Small portable devices of today, typified by a digital still camera, are required to be small, power saving, and cost effective. Thus, it is necessary to reduce the amount of calculation, the necessary memory, and the number of times data stored in the memory is accessed.

To address this, an idea of reducing the number of reference pictures has been proposed. Japanese Unexamined Patent Application Publication No. 2006-094454 (referred to as Patent Reference 1 hereafter) discloses that the compression efficiency does not decrease even after the number of reference pictures is reduced to three. More specifically, Patent Reference 1 discloses a rule by which: a picture temporally close to a coding-target picture is preferentially selected as a reference picture when an estimated motion size is large; and a picture having the same parity as the coding-target picture is preferentially selected as a reference picture when the estimated motion size is small.

FIG. 12 is a block diagram showing an example of an image coding device according to Patent Reference 1. As shown in FIG. 12, an image coding device 200 includes an input image memory 201, an orthogonal transformation unit 202, a quantization unit 203, a variable-length coding unit 204, an inverse quantization unit 205, an inverse orthogonal transformation unit 206, a reference picture memory 207, and a motion estimation-compensation unit 208.

A video signal received by the image coding device 200 is stored into the input image memory 201. The motion estimation-compensation unit 208 calculates motion vectors using three reference pictures stored in the reference picture memory 207, and determines the sizes of the motion vectors to search for a reference picture which is most correlated with the video signal and for positions of macroblocks. Then, a difference between macroblocks of the obtained reference picture and the received video signal is calculated, and a difference signal is sent to the orthogonal transformation unit 202 and the quantization unit 203. The variable-length coding unit 204 performs variable-length coding on the quantized difference signal, and sends this signal, as coded data, to an external source outside the image coding device 200. The coded data is also sent to the inverse quantization unit 205 and the inverse orthogonal transformation unit 206, and then a difference signal is outputted. This difference signal is added to one of the temporally preceding pictures stored in the reference picture memory 207, and the reference pictures in the reference picture memory 207 are accordingly updated.

Moreover, Japanese Unexamined Patent Application Publication No. 2008-011117 (referred to as Patent Reference 2 hereafter) discloses a method of reducing the number of reference pictures from three to two.

In addition to the method disclosed by Patent Reference 1, the method disclosed by Patent Reference 2 classifies coding-target pictures according to the following (1) to (3) based on video-signal characteristics information indicating the motion size, and accordingly selects a reference picture for each of the coding-target pictures.

(1) When the fields of the frame have a strong correlation with each other, a field having the opposite parity to the coding-target picture is selected as the reference picture. (2) When the fields of the frame have a weak correlation with each other and a motion of the image is large, a picture which is referable and temporally closest to the coding-target picture is selected as the reference picture. (3) When a motion of the image is small, a field which has the same parity as the coding-target picture and which is referable and temporally closest to the coding-target picture is selected as the reference picture. With this method, the number of reference pictures can be reduced to two without any loss in picture quality.

It should be noted that, as the motion size, an average value of motion vectors of each macroblock included in the frame may be used.

### SUMMARY OF THE INVENTION

However, the conventional methods have the problems as follows.

The conventional method reduces the number of reference pictures without any loss in picture quality, by using, as the reference picture, the same-parity field in the case of a small motion and the temporally-closest referable field, namely, the opposite-parity field in the case of a large motion. That is to say, the reference field is switched based on the motion size.

However, the conventional method does not define a correlation between a motion search range (i.e., a reference field) and a motion size. On account of this, using the method by which the reference field is switched based on the motion size, even though the motion estimation is adequately performed using the current reference field, the reference field may be switched from the same-parity field to the opposite-parity field, depending on a threshold used for motion determination. On the contrary, even though the motion estimation is not adequately performed, the reference field may be switched from the opposite-parity field to the same-parity field. In other words, the reference field may be switched at the wrong timing or may not be switched at the right timing when the reference field needs to be switched. This leads to a problem that a resultant decoded image may possibly have noise.

FIGS. 13A and 13B are diagrams explaining the conventional problem. Suppose that a landscape as shown in FIG. 13A is shot. A lower part of the landscape shown in FIG. 13A includes trees, indicating a complicated image. An upper part of the landscape in FIG. 13A includes the expanding sky, indicating a simple image. Video of this landscape is recorded by a camera which pans in a direction such that images are shot in the following order: (1), (2), (3), (4), and (5). Here, note that the fields (1), (3), and (5) are top fields, and that the fields (2) and (4) are bottom fields. Depending on the motion size, a same-parity field is always selected as the reference field. To be more specific, when the field (3) is the coding-target field, a difference between the fields (3) and (1) is coded. Similarly, when the field (4) is the coding-target field, a difference between the fields (4) and (2) is coded. Moreover, when the field (5) is the coding-target field, a difference between the fields (5) and (3) is coded.

FIG. 13B shows a result obtained by decoding the fields (3) to (5). Although having the simple images, the fields (4) and (5) are coded using the fields (2) and (3), respectively, as the reference fields, each of which has the complicated image. As a result, the decoded images of the fields (4) and (5) include blurring caused by the images of the fields (2) and (3), respectively. That is to say, when a complicated scene changes to a simple scene, noise occurs to the decoded result of the simple image.

The present invention is conceived in view of the stated problem, and has an object to provide an image coding device which prevents noise from occurring to a decoded result even in the case of a scene change.

The present invention is conceived to solve the conventional problem, and the image coding device according to an aspect of the present invention is an image coding device which performs predictive coding on a moving image having a field structure, the image coding device including: an inter-coding prediction unit which calculates a predicted inter-coding amount indicating a predicted amount of coding required to perform inter prediction on a coding-target field which is a target of predictive coding, when a reference picture is a same-parity field having a same parity as the coding-target field; an intra-coding prediction unit which calculates a predicted intra-coding amount indicating a predicted amount of coding required to perform intra prediction on the coding-target field; a reference picture selection unit which compares the predicted inter-coding amount and the predicted intra-coding amount, and switches the reference picture from the same-parity field to a temporally-closest referable field which is referable and temporally closest to the coding-target field upon determining that the predicted inter-coding amount is relatively larger than the predicted intra-coding amount; and a predictive coding unit which performs the predictive coding on the coding-target field using the reference picture.

With this configuration, at the timing appropriate to the coding-target field, the reference picture can be switched between the same-parity field and the temporally-closest referable field. This can reduce noise which may occur to the decoded image as a result of the reference field switching.

The temporally-closest referable field refers to an immediately preceding field and to an immediately following field in order of reproduction. This means that two reference pictures can be used at the maximum. With this, the memory access to the reference pictures and the amount of calculation required for the motion estimation can be reduced.

The predicted intra-coding amount is an evaluation value used for determining whether to perform the intra prediction. Similarly, the predicted inter-coding amount is an evaluation value used for determining whether to perform the inter prediction. Therefore, the reference picture switching can be executed without having to add a new evaluation value.

Preferably, (i) when the same-parity field is used as the reference picture, the reference picture selection unit switches the reference picture from the same-parity field to the temporally-closest referable field upon determining that the value obtained by dividing the predicted inter-coding amount by the predicted intra-coding amount is equal to or larger than a first determination threshold, and (ii) when the temporally-closest referable field is used as the reference picture, the reference picture selection unit switches the reference picture from the temporally-closest referable field to the same-parity field upon determining that the value obtained by dividing the predicted inter-coding amount by the predicted intra-coding amount is smaller than a second determination threshold which is smaller than the first determination threshold.

In this way, by using the two determination thresholds for executing the reference picture switching, flexibility is provided. More specifically, the reference picture switching is not influenced by a sudden change in the value obtained by dividing the predicted inter-coding amount by the predicted intra-coding amount. Thus, the reference picture switching can be executed with stability. This reduces the dependence on a subject of video shooting, thereby reducing errors in the motion estimation. Accordingly, the coding processing can be performed without any decrease in the coding efficiency.

Preferably, the reference picture selection unit smoothes the predicted inter-coding amount and the predicted intra-coding amount in a direction of time to compare the smoothed predicted inter-coding amount and the smoothed predicted intra-coding amount, and switches the reference picture from the same-parity field to the temporally-closest referable field upon determining that the smoothed predicted inter-coding amount is relatively larger than the smoothed predicted intra-coding amount.

Since the predicted inter-coding amount and the predicted intra-coding amount are smoothed in the time direction in this way, there is no sudden change in the predicted inter-coding amount and the predicted intra-coding amount. This can prevent the reference picture from being frequently switched. In other words, the reference picture switching can be executed with stability. This reduces the dependence on a subject of video shooting, thereby reducing errors in the motion estimation. Accordingly, the coding processing can be performed without any decrease in the coding efficiency.

It should be noted that the present invention can be implemented not only as an image coding device including the characteristic processing units as described above, but also as an image coding method having, as steps, the characteristic processing units included in the image coding device. Also, the present invention can be implemented as a computer program causing a computer to execute the characteristic steps included in the image coding method. It should be obvious that such a computer program can be distributed via a computer-readable recording medium such as a Compact Disc-Read Only Memory (CD-ROM) or via a communication network such as the Internet.

According to the present invention, the reference picture can be switched between the same-parity field and the temporally-closest referable field, at the timing appropriate to the coding-target field. This can reduce noise which may occur to the decoded image as a result of the reference field switching. Moreover, since two reference pictures can be used at the maximum, the memory access to the reference pictures and the amount of calculation required for the motion estimation can be reduced.

### FURTHER INFORMATION ABOUT TECHNICAL BACKGROUND TO THIS APPLICATION

The disclosure of Japanese Patent Application No. 2009-075160 filed on Mar. 25, 2009 including specification, drawings and claims is incorporated herein by reference in its entirety.

The disclosure of PCT application No. PCT/JP2009/006718 filed on Dec. 9, 2009, including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a block diagram showing a configuration of an image coding device in a first embodiment according to the present invention;

FIG. 2 is a flowchart showing processing performed by a reference picture selection unit to select a reference picture;

FIG. 3 is a diagram showing a subject and a manner of shooting video of the subject, in the first embodiment according to the present invention;

FIG. 4A is a diagram showing changes in ACT when the subject shown in FIG. 3 is shot;

FIG. 4B is a diagram showing changes in SAD when the subject shown in FIG. 3 is shot;

FIG. 4C is a diagram showing changes in SAD/ACT when the subject shown in FIG. 3 is shot;

FIG. 5A is a diagram showing a result of reference picture selection of when a coding-target field is a P-picture;

FIG. 5B is a diagram showing a result of reference picture selection of when the coding-target field is a B-picture;

FIG. 5C is a diagram showing a result of reference picture selection of when the coding-target field is a P-picture;

FIG. 5D is a diagram showing a result of reference picture selection of when the coding-target field is a B-picture;

FIG. 6A is a diagram showing a reproduction result of a video image coded by the image coding device;

FIG. 6B is a diagram showing a reproduction result of a video image coded by the image coding device;

FIG. 7A is a diagram explaining a method of setting a determination threshold in a first modification of the first embodiment according to the present invention;

FIG. 7B is a diagram explaining a method of setting determination thresholds in the first modification of the first embodiment according to the present invention;

FIG. 8 is a flowchart showing processing performed by the reference picture selection unit to select a reference picture in the first modification of the first embodiment according to the present invention;

FIG. 9 is a diagram explaining a method of calculating SAD_AVE and ACT_AVE in a second modification of the first embodiment according to the present invention;

FIG. 10 is a block diagram showing a configuration of an image pickup system in a second embodiment according to the present invention;

FIG. 11 is a diagram showing a top field and a bottom field in an interlaced image;

FIG. 12 is a block diagram showing an example of a conventional image coding device;

FIG. 13A is a diagram explaining a conventional problem; and

FIG. 13A is a diagram explaining a conventional problem.

### DESCRIPTION OF THE PREFERRED EMBODIMENTS

The following is a description of the embodiments according to the present invention, with reference to the drawings. In the present invention, a field in an interlaced image is referred to as a picture and each picture is coded.

### First Embodiment

### [Configuration of Image Coding Device]

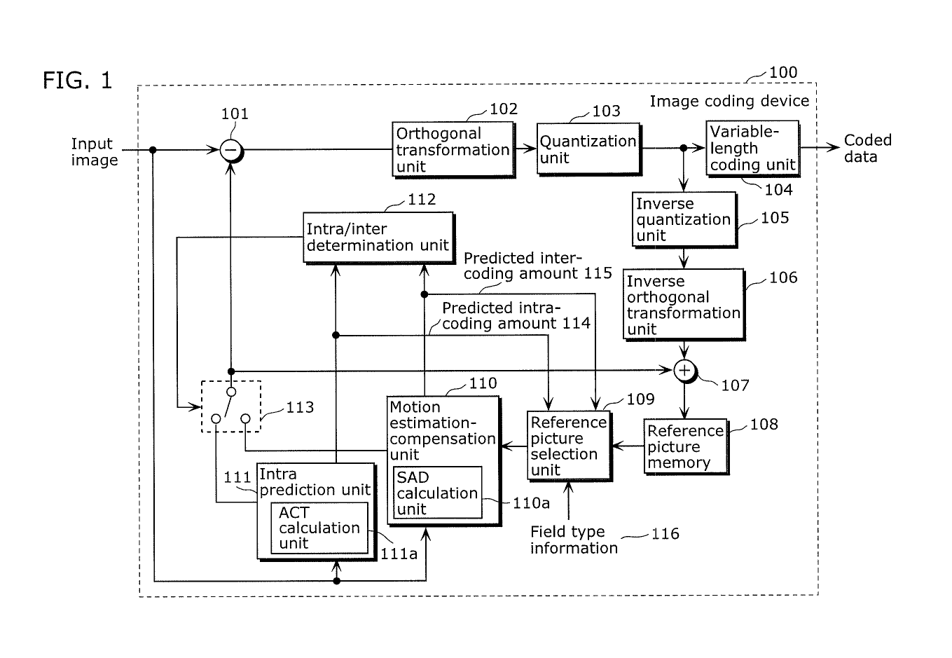

FIG. 1 is a block diagram showing a configuration of an image coding device in the first embodiment according to the present invention.

An image coding device 100 codes a received image and outputs the coded data. The image coding device 100 includes a subtracter 101, an orthogonal transformation unit 102, a quantization unit 103, a variable-length coding unit 104, an inverse quantization unit 105, an inverse orthogonal transformation unit 106, an adder 107, a reference picture memory 108, and a reference picture selection unit 109, a motion estimation-compensation unit 110, an intra prediction unit 111, an intra/inter determination unit 112, and a selector 113.

The subtracter 101 calculates a difference between an input image received from an external source and a reference picture received from the motion estimation-compensation unit 110, and outputs difference data indicating a result of the calculation.

The orthogonal transformation unit 102 performs orthogonal transformation on the difference data.

The quantization unit 103 quantizes the orthogonally-transformed data.

The variable-length coding unit 104 performs variable-length coding on the quantized data, and sends the variable-length coded data, as coded data, to an external source.

That is to say, the subtracter 101, the orthogonal transformation unit 102, the quantization unit 103, and the variable-length coding unit 104 perform predictive coding on a coding-target field using the reference picture.

The inverse quantization unit 105 performs inverse quantization on the quantized data received from the quantization unit 103.

The inverse orthogonal transformation unit 106 performs inverse orthogonal transformation on the data inversely quantized by the inverse quantization unit 105.

The adder 107 adds the data on which the inverse orthogonal transformation has been performed by the inverse orthogonal transformation unit 106 and a predicted picture received from the selector 113. Then, the adder 107 stores a result of the addition as a reconstructed picture into the reference picture memory 108.

The reference picture memory 108 stores, as reference picture candidates: two fields immediately preceding the coding-target field in order of reproduction; and two fields immediately following the coding-target field in order of reproduction. Here, each of the reference picture candidates is one of an I-picture, a P-picture, and a referable B-picture.

The reference picture selection unit 109 selects an appropriate reference picture from among the pictures stored in the reference picture memory 108, based on a predicted inter-coding amount 115, a predicted intra-coding amount 114, and field type information 116. Then, the reference picture selection unit 109 sends the selected reference picture to the motion estimation-compensation unit 110. Here, the predicted intra-coding amount 114 is outputted from the intra prediction unit 111 and indicates a predicted amount of coding required for intra prediction. The predicted inter-coding amount 115 is outputted from the motion estimation-compensation unit 110 and indicates a predicted amount of coding required for inter prediction. The field type information 116 indicates whether a coding-target macroblock which is currently being processed belongs to a top field or a bottom field. More specifically, the reference picture selection unit 109 first compares the predicted inter-coding amount 115 and the predicted intra-coding amount 114. Upon determining that the predicted inter-coding amount 115 is relatively larger than the predicted intra-coding amount 114, the reference picture selection unit 109 switches the reference picture from the field having the same parity as the coding-target field to the field referable and temporally closest to the coding-target field. Hereafter, the field having the same parity as the coding-target field may be simply referred to as the “same-parity field”, and the field referable and temporally closest to the coding-target field may be simply referred to as the “temporally-closest referable field”. The predicted intra-coding amount 114 and the predicted inter-coding amount 115 are described later in detail.

The motion estimation-compensation unit 110 includes an SAD calculation unit 110a which calculates the predicted inter-coding amount 115. Here, “SAD” stands for Sum of Absolute Differences. Based on the reference picture received from the reference picture selection unit 109 and the data of the coding-target macroblock included in the input image, the motion estimation-compensation unit 110 performs motion estimation. After this, the motion estimation-compensation unit 110 performs motion compensation. Then, the motion estimation-compensation unit 110 sends an image obtained as a result of the motion compensation to the selector 113 as well as sending the predicted inter-coding amount 115 to the intra/inter determination unit 112 and the reference picture selection unit 109. When the reference picture is a field having the same parity as the coding-target field which is a target of predictive coding, the SAD calculation unit 110a calculates a predicted inter-coding amount indicating a predicted amount of coding required to perform inter prediction on the coding-target field.

The intra prediction unit 111 includes an ACT calculation unit 111a which calculates the predicted intra-coding amount 114. Here, “ACT” is an abbreviation of “activity”. The intra prediction unit 111 sends a result of the intra prediction performed on the input image to the selector 113, and also sends the predicted intra-coding amount 114 to the reference picture selection unit 109. The ACT calculation unit 111a calculates a predicted intra-coding amount indicating a predicted amount of coding required to perform intra prediction on the coding-target field.

The intra/inter determination unit 112 determines whether to perform intra prediction or inter prediction on the coding-target field, based on the predicted intra-coding amount 114 and the predicted inter-coding amount 115. Then, the intra/inter determination unit 112 notifies the selector 113 of the determined prediction mode.

According to the prediction mode determined by the intra/inter determination unit 112, the selector 113 sends the predicted picture to the subtracter 101.

### [Predicted Intra-coding Amount and Predicted Inter-coding Amount]

Next, the predicted intra-coding amount and the predicted inter-coding amount are explained in detail.

In the present embodiment, the predicted intra-coding amount is of the coding-target field obtained as follows. Firstly, an absolute difference is calculated between a luminance value of each pixel in each of macroblocks included in the coding-target field and an average luminance value of the macroblock. The calculated differences are summed for each of the macroblocks, and then the summed differences of the macroblocks are summed to obtain a sum of absolute differences in the coding-target field. This obtained sum is the predicted intra-coding amount and, hereafter, referred to as “ACT” which is an abbreviation for “activity” as mentioned above. It should be noted that the method of calculating the predicted intra-coding amount is not limited to this. For example, instead of the average luminance value in the target macroblock, luminance values of pixels located on the left side of the target macroblock or located on the upper side of the target macroblock may be used. That is to say, a difference may be calculated in accordance with the intra prediction mode.

Moreover, in the present embodiment, the predicted inter-coding amount of the coding-target field is obtained as follows. Firstly, an absolute difference in luminance is calculated between each pixel in each of macroblocks included in the coding-target field and a corresponding pixel in a macroblock included in the reference picture. The calculated differences are summed for each of the macroblocks, and then the summed differences of the macroblocks are summed to obtain a sum of absolute differences in the coding-target field. This obtained sum is the predicted inter-coding amount and, hereafter, referred to as “SAD” which stands for “Sum of Absolute Differences” as mentioned above. It should be noted that the reference picture used for coding the immediately preceding picture may be used again as the reference picture for the current picture. Moreover, as the macroblock in the reference picture corresponding to the coding-target macroblock, a macroblock located in the picture at the same position as the coding-target macroblock may be used. Alternatively, in consideration of a motion of the coding-target macroblock, a macroblock located in the picture at a different position from the coding-target macroblock may be used. When the macroblock located in the picture at the same position as the coding-target macroblock is used, the aforementioned SAD is calculated as the absolute sum of differences in luminance between the coding-target picture and the reference picture.

### [Reference Picture Selection Processing]

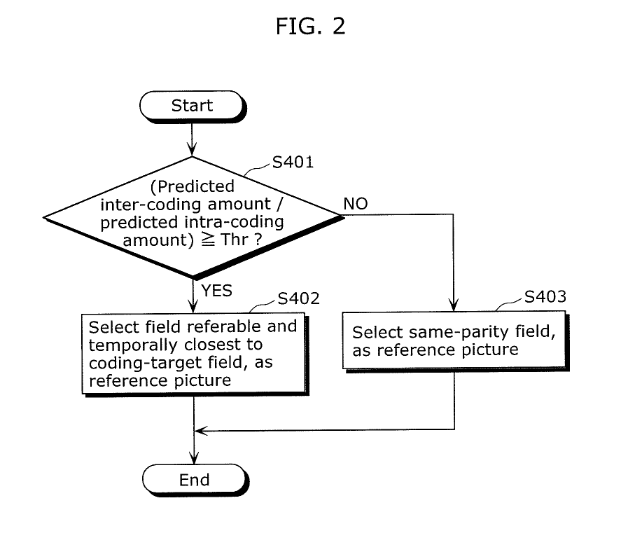

FIG. 2 is a flowchart showing the processing performed by the reference picture selection unit 109 to select a reference picture. Note that, as an initial setting in the present embodiment, the reference picture is to be selected from among fields having the same parity as the coding-target field. Moreover, before the reference picture selection processing is performed, the SAD calculation unit 110a calculates the SAD and the ACT calculation unit 111a calculates the ACT.

The reference picture selection unit 109 receives the predicted intra-coding amount 114 (namely, the ACT) and the predicted inter-coding amount 115 (namely, the SAD) and determines whether or not a relation expressed by “(predicted inter-coding amount/predicted intra-coding amount)≧Thr”, that is, “(SAD/ACT)≧Thr”, is satisfied (S401). Here, “Thr” represents a determination threshold which is a small value satisfying 0<Thr≦1.

When the relation “(predicted inter-coding amount/predicted intra-coding amount)≧Thr”, i.e., “(SAD/ACT)≧Thr”, is satisfied (YES in S401), this means that the motion estimation performed using the current reference picture (having the same parity as the coding-target field) is inaccurate. To be more specific, a scene is predicted to have a large motion. Thus, the reference picture selection unit 109 selects a “temporally-closest referable field” as the reference picture (S402). As a result, the reference picture is switched from the same-parity field to the temporally-closest referable field. After the process of S402, the predictive coding is performed on the coding-target field using the selected reference picture.

On the other hand, when a relation expressed by “(predicted inter-coding amount/predicted intra-coding amount)<Thr”, i.e., “(SAD/ACT)<Thr”, is satisfied (NO in S401), this means that the motion estimation performed using the current reference picture (having the same parity as the coding-target field) is adequately accurate. To be more specific, a scene is predicted to have a small motion. In general, a correlation between the fields of the same parity is strong in the interlaced images. Thus, the reference picture selection unit 109 selects a “same-parity field” as the reference picture (S403). As a result, the same-parity field remains as the reference picture and, therefore, the reference picture switching is not performed. After the process of S403, the predictive coding is performed on the coding-target field using the selected reference picture.

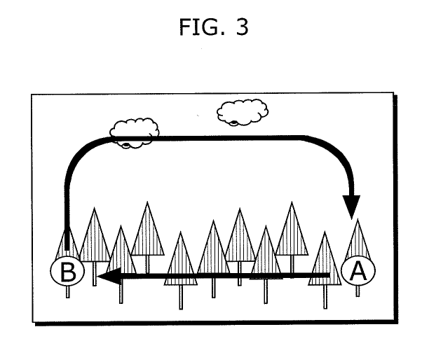

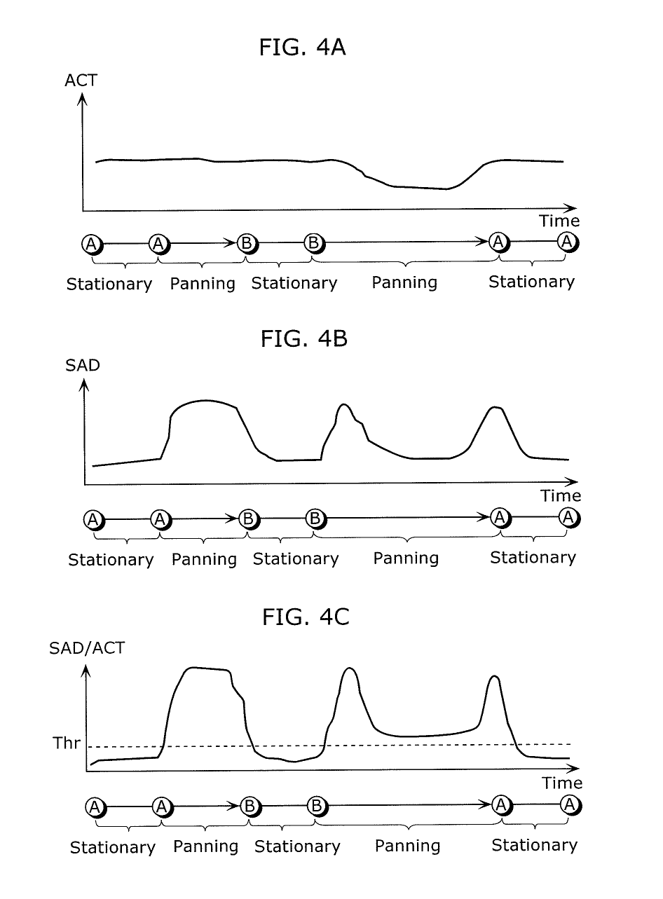

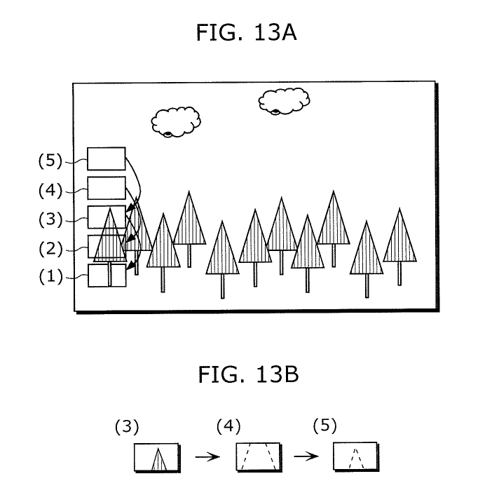

The following describes a method of selecting a reference picture in video obtained by shooting a landscape shown in FIG. 3. The landscape shown in FIG. 3 is identical to the landscape shown in FIG. 13A and, therefore, the detailed explanation of the landscape is not repeated here. Suppose that the landscape is shot by, for example, a camera in the following manner. The camera is stationary at first to shoot a point A, then pans in the left direction to shoot a point B where the camera is stationary again. Then, after panning across the sky, the camera returns to shoot the point A. FIGS. 4A and 4B show changes in SAD and in ACT, respectively, in the case of the video shooting as shown in FIG. 3.

As shown in FIG. 4A, the ACT stays high between the point A to the point B. This is because the images shot from the point A to the point B are complicated and, thus, a difference between the average luminance value and the pixel value varies for each pixel in the target macroblock. Then, when the camera pans to shoot the sky, the shot images are of a low frequency, meaning that the ACT decreases. After this, when the camera returns to shoot the point A, the ACT increases again.

As shown in FIG. 4B, the SAD starts low since the predicted image is considered accurate while the camera is stationary to shoot the point A. Next, when the camera pans fast to shoot the point B, it becomes hard to obtain accurate predicted images. Thus, the SAD suddenly increases. While the camera is stationary to shoot the point B, the SAD decreases to a small value again because the predicted images are accurate. After this, while the camera is panning and shooting the trees, the SAD stays high. Then, when the camera starts shooting the sky, the shot images are of a low frequency, meaning that the SAD decreases to a small value because the predicted images are basically accurate. Following this, just before the camera returns to shoot the point A, the SAD increases once again since the trees are shot. Then, the camera is stationary to shoot the point A and, thus, the SAD decreases to a small value.

The SAD and ACT show the changes as described above, and FIG. 4C shows changes in SAD/ACT. Suppose here that a determination threshold Thr is set as shown in FIG. 4C. It can be seen from FIG. 4C that, at times where the relation “(SAD/ACT)≧Thr” is satisfied, the camera is panning to shoot the moving images.

When the sky is shot while the camera is panning from the point B to the point A, the SAD deceases and so does the ACT. More specifically, SAD/ACT is equal to or larger than the determination threshold Thr and the moving images are accurately predicted.

According to the conventional method, an average value of motion vectors in each macroblock included in the frame is used for motion determination. Here, when the sky is shot using the conventional method while the camera is panning from the point B to the point A, the motion vector value of each macroblock is small since the shot images are simple. As a result, the images are determined to have small motions. This means that the reference picture is switched from the opposite-parity field to the same-parity field, which leads to a problem that the decoded images may have noise

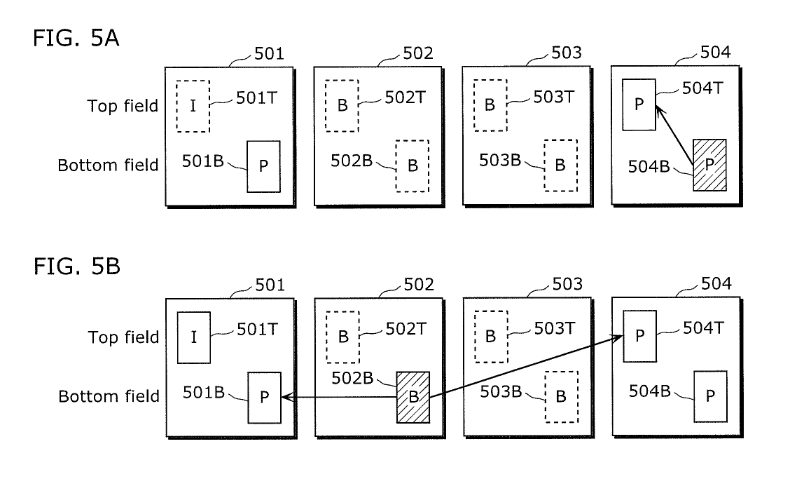

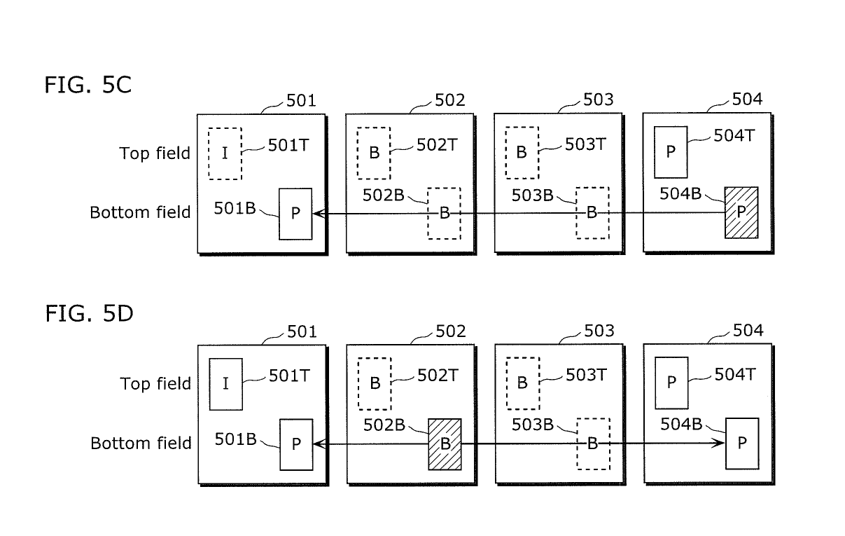

This result is explained based on the cases where the coding-target field is a P-picture and a B-picture, with reference to FIGS. 5A to 5D.

In each of FIGS. 5A to 5D, suppose that an image 501, an image 502, an image 503, and an image 504 are shot in this order. Note that each of the images 501 to 504 includes a top field and a bottom field. For example, the image 501 includes a top field 501T and a bottom field 501B. Moreover, each field, and more specifically, each picture is classified as an I-picture, a P-picture, or a B-picture, as shown. For example, the top field 501T is an I-picture and the bottom field 501B is a P-picture.

FIG. 5A shows the case where the relation “(predicted inter-coding amount/predicted intra-coding amount)≧Thr” is satisfied and the coding-target field is a bottom field 504B which is a P-picture. In this case, two pictures immediately temporally preceding the bottom field 504B, i.e., the bottom field 501B and a top field 504T, are reference picture candidates. It should be noted that, in the present embodiment, a B-picture cannot be a reference picture candidate. The reference picture candidate which is temporally closest to the bottom field 504B is the top field 504T having the opposite parity to the bottom field 504B. Accordingly, the top field 504T is selected as the reference picture.

FIG. 5B shows the case where the relation “(predicted inter-coding amount/predicted intra-coding amount)≧Thr” is satisfied and the coding-target field is a bottom field 502B which is a B-picture. In this case, two pictures immediately temporally preceding the bottom field 502B, i.e., the top field 501T and the bottom field 501B, and two pictures immediately temporally following the bottom field 502B, i.e., the top field 504T and the bottom field 504B, are reference picture candidates. The reference picture candidates which are temporally closest to the bottom field 502B is: the bottom field 501B which temporally precedes the bottom field 502B and has the same parity as the bottom field 502B; and the top field 504T which temporally follows the bottom field 502B and has the opposite parity to the bottom field 502B. Accordingly, the bottom field 501B and the top field 504T are selected as the reference pictures. Here, when the coding-target field is a top field, the following fields are selected as the reference pictures: a temporally-closest preceding referable field, that is, an opposite-parity field; and a temporally-closest following referable field, that is, a same-parity field.

FIG. 5C shows the case where the relation “(predicted inter-coding amount/predicted intra-coding amount)<Thr” is satisfied and the coding-target field is the bottom field 504B which is a P-picture. In this case, two pictures immediately temporally preceding the bottom field 504B, i.e., the bottom field 501B and the top field 504T, are reference picture candidates. The reference picture candidate which has the same parity as the bottom field 504B is the bottom field 501B. Accordingly, the bottom field 501B is selected as the reference picture.

FIG. 5D shows the case where the relation “(predicted inter-coding amount/predicted intra-coding amount)<Thr” is satisfied and the coding-target field is the bottom field 502B which is a B-picture. In this case, two pictures immediately temporally preceding the bottom field 502B, i.e., the top field 501T and the bottom field 501B, and two pictures immediately temporally following the bottom field 502B, i.e., the top field 504T and the bottom field 504B, are reference picture candidates. The fields having the same parity as the bottom field 502B are: the bottom field 501B temporally preceding the bottom field 502B; and the bottom field 504B temporally following the bottom field 502B. Accordingly, the bottom field 501B and the bottom field 504B are selected as the reference pictures.

Here, suppose that the predictive coding is performed on the coding-target field which is a P picture. In this case, the reference picture selection unit 109 first compares the predicted inter-coding amount 115 and the predicted intra-coding amount 114. Upon determining that the predicted inter-coding amount 115 is relatively larger than the predicted intra-coding amount 114, the reference picture selection unit 109 switches the reference picture from the same-parity field to the temporally-closest referable field, each of the same-parity field and the temporally-closest referable field being the reference picture candidate.

Moreover, suppose that the predictive coding is performed on the coding-target field which is a B picture. In this case, the reference picture selection unit 109 first compares the predicted inter-coding amount 115 and the predicted intra-coding amount 114. Upon determining that the predicted inter-coding amount 115 is relatively larger than the predicted intra-coding amount 114, the reference picture selection unit 109 selects, as the reference pictures from among the reference picture candidates, the temporally-closest referable field out of the two immediately preceding fields and the temporally-closest referable field out of the two immediately following fields.

In the case of the conventional method whereby a reference picture is determined only from a motion, correlation between the motion size and the amount of coding is not taken into consideration. For this reason, as shown in FIG. 13A, the same-parity field may always end up being selected as the reference picture, depending on a threshold used for motion determination. As a result of using the conventional method, the decoded images of the fields (4) and (5) include blurring caused by the images of the fields (2) and (3), respectively. That is to say, when a complicated scene changes to a simple scene, noise occurs to the decoded result of the simple image.

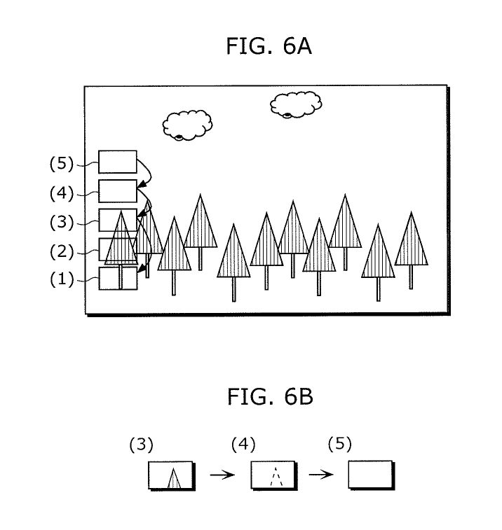

Using the method in the present invention, however, the reference picture is determined on the basis of the amount of coding, as shown in FIG. 6A. Therefore, when a complicated scene changes into a simple scene, the reference picture is switched from the same-parity field to the temporally-closest referable field. To be more specific, when the coding-target fields is the field (3), the field (1) having the same parity as the field (3) is selected as the reference picture. When the fields (4) and (5) each having a simple image are the coding-target fields, the fields (3) and (4) having the opposite parity to the fields (4) and (5), respectively, are selected as the respective reference pictures.

FIG. 6B shows decoded results of the fields (3) to (5). Since the field (4) is used as the reference picture for the field (5), blurring is not included in the decoded result of the field (5). As compared to the conventional case, noise is prevented from occurring.

According to the image coding device in the present embodiment as described thus far, the reference picture can be switched between the same-parity field and the temporally-closest referable field, at the timing appropriate to the coding-target field. Hence, noise occurring at the time of the reference picture switching can be reduced. Moreover, by using two reference pictures, the number of times the reference pictures stored in the memory are accessed can be reduced and the amount of calculation required for motion estimation can also be reduced.

The predicted intra-coding amount is an evaluation value used for determining whether to perform the intra prediction. Similarly, the predicted inter-coding amount is an evaluation value used for determining whether to perform the inter prediction. Therefore, the reference picture switching can be executed without having to add a new evaluation value.

### First Modification of First Embodiment

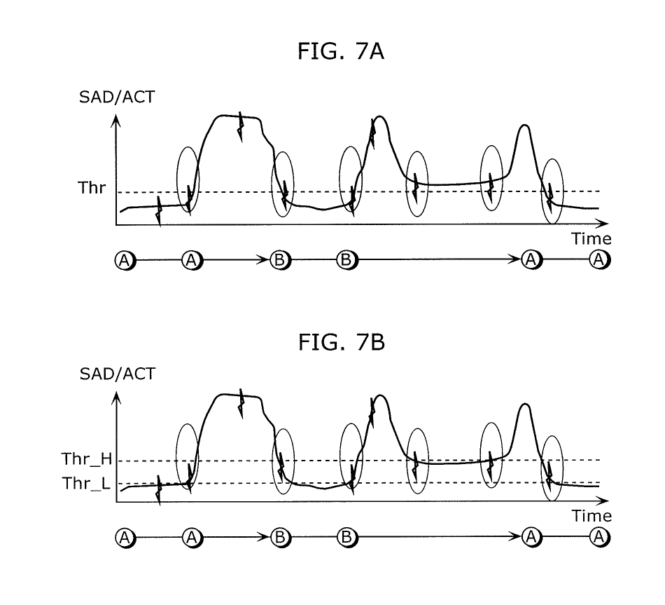

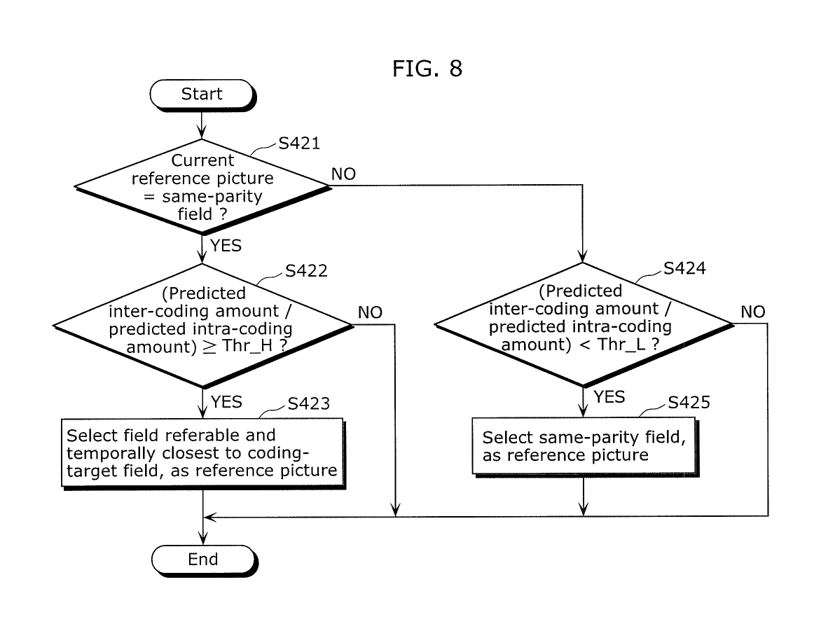

The first embodiment has described that it is appropriate to use the SAD and the ACT for scene determination. However, when natural scenery is actually shot and SAD/ACT is calculated, a resultant graph is not as smooth as the graph shown in FIG. 4C. It can be easily assumed that the actual graph includes abrupt changes like pulse noise, as shown in FIG. 7A. It should be noted that FIG. 7A shows abrupt changes only at nine positions in the graph for the sake of convenience and that, in reality, abrupt changes occur everywhere in the graph.

In the case where a natural scene image is coded and the reference picture switching is performed using only one determination threshold Thr of SAD/ACT as in the first embodiment, the reference picture is switched frequently when the SAD/ACT value is around the determination threshold Thr. As a result, errors in the motion estimation increase and the coding efficiency decreases.

To address this, the first modification of the first embodiment describes a method capable of correctly selecting the reference picture even in the above case. It should be noted that a configuration of an image coding device in the first modification of the first embodiment is the same as that of the image coding device in the first embodiment. Therefore, only the points of difference are described in the present modification.

In the first modification, hysteresis is provided for the determination threshold of SAD/ACT, as shown in FIG. 7B. To be more specific, a determination threshold Thr_H is used for determining whether to select, as the reference picture, a temporally-closest referable field. Moreover, a determination threshold Thr_L is used for determining whether to select, as the reference picture, a same-parity field. Here, the following three relations are satisfied: Thr_H>Thr_L; 0<Thr_H≦1; and 0<Thr_L ≦1.

FIG. 8 is a flowchart showing processing performed by the reference picture selection unit 109 to select a reference picture, based on the determination threshold with hysteresis. Note that, as an initial setting in the present modification, the reference picture is to be selected from among fields having the same parity as the coding-target field.

The reference picture selection unit 109 determines whether or not the current reference picture is of the same parity as the coding-target field (S421). When determining that the current reference picture is of the same parity as the coding-target field (YES in S421), the reference picture selection unit 109 receives the predicted intra-coding amount 114 (namely, the ACT) and the predicted inter-coding amount 115 (namely, the SAD) and determines whether or not a relation expressed by “(predicted inter-coding amount/predicted intra-coding amount)≧Thr_H”, that is, “(SAD/ACT)≧Thr_H”, is satisfied (S422).

When a relation expressed by “(predicted inter-coding amount/predicted intra-coding amount)≧Thr_H”, i.e., “(SAD/ACT)≧Thr_H”, is satisfied (YES in S422), this means that the motion estimation performed using the current reference picture (having the same parity as the coding-target field) is inaccurate. To be more specific, a scene is predicted to have a large motion. Thus, the reference picture selection unit 109 selects a “temporally-closest referable field” as the reference picture (S423).

When the relation “(predicted inter-coding amount/predicted intra-coding amount)<Thr_H”, i.e., “(SAD/ACT)<Thr_H”, is satisfied (NO in S422), the same-parity field remains as the reference picture and, therefore, the reference picture switching is not performed.

When determining that the current reference picture is not of the same parity as the coding-target field, that is, when the temporally-closest referable field is used as the reference picture (NO in S421), the reference picture selection unit 109 receives the predicted intra-coding amount 114 (namely, the ACT) and the predicted inter-coding amount 115 (namely, the SAD) and determines whether or not a relation expressed by “(predicted inter-coding amount/predicted intra-coding amount)<Thr_L”, that is, “(SAD/ACT)<Thr_L”, is satisfied (S424).

When the relation “(predicted inter-coding amount/predicted intra-coding amount)<Thr_L”, i.e., “(SAD/ACT)<Thr_L”, is satisfied (YES in S424), this means that the motion estimation performed using the current reference picture (i.e., the temporally-closest referable field) is inaccurate. To be more specific, a scene is predicted to have a small motion. In general, a correlation between the fields of the same parity is strong in the interlaced images. Thus, the reference picture selection unit 109 selects a “same-parity field” as the reference picture (S425).

When a relation expressed by “(predicted inter-coding amount/predicted intra-coding amount)≧Thr_L”, i.e., “(SAD/ACT)≧Thr_L”, is satisfied (NO in S424), the temporally-closest referable field remains as the reference picture and, therefore, the reference picture switching is not performed.

In this way, by extending a range of the determination threshold used for the reference picture switching, the reference picture switching is not influenced by the sudden changes circled in the graph shown in FIG. 7A. Thus, the reference picture switching can be executed with stability. This reduces the dependence on a subject of video shooting, thereby reducing errors in the motion estimation. Accordingly, the coding processing can be performed without any decrease in the coding efficiency.

### Second Modification of First Embodiment

As described in the first modification above, when natural scenery is actually shot, a resultant graph is not as smooth as the graph shown in FIG. 4C. It can be easily assumed that the actual graph includes abrupt changes like pulse noise, as shown in FIG. 7A. It should be noted that FIG. 7A shows abrupt changes only at nine positions in the graph and that, in reality, abrupt changes occur everywhere in the graph.

In the case where a natural scene image is coded and the reference picture switching is performed using only one determination threshold Thr of SAD/ACT as in the first embodiment, the reference picture switching is performed frequently when the SAD/ACT value is around the determination threshold Thr. As a result, errors in the motion estimation increase and the coding efficiency decreases.

To address this, the second modification of the first embodiment describes a method capable of correctly selecting the reference picture even in the above case. It should be noted that a configuration of an image coding device in the second modification of the first embodiment is the same as that of the image coding device in the first embodiment. Therefore, only the points of difference are described in the present modification.

In the second modification, the obtained SAD graph and ACT graph are smoothed in the direction of time to calculate a SAD average, i.e., SAD_AVE, and an ACT average, i.e., ACT_AVE. Based on SAD_AVE and ACT_AVE, the reference picture is selected.

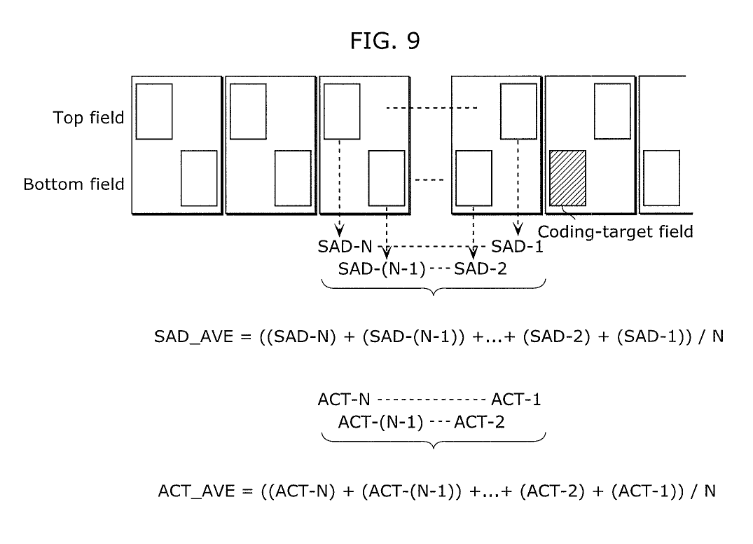

FIG. 9 is a diagram explaining a method of calculating SAD_AVE and ACT AVE in the second modification of the first embodiment according to the present invention.

More specifically, SAD_AVE refers to an average of SADs of N number of fields immediately preceding the coding-target field. Similarly, ACT_AVE refers to an average of ACTs of the N number of fields immediately preceding the coding-target field.

In the second modification, the reference picture selection unit 109 calculates: SAD_AVE instead of SAD; ACT_AVE instead of ACT; and SAD_AVE/ACT_AVE instead of SAD/ACT.

After this, according to the flowchart shown in FIG. 2, the reference picture selection unit 109 determines whether or not a relation expressed by “SAD_AVE/ACT_AVE≧Thr” is satisfied and selects the reference picture as in the first embodiment.

To be more specific, the reference picture selection unit 109 smoothes the predicted inter-coding amount and the predicted intra-coding amount in the direction of time to compare the smoothed predicted inter-coding amount and the smoothed predicted intra-coding amount. Upon determining that the smoothed predicted inter-coding amount is relatively larger than the smoothed predicted intra-coding amount, the reference picture selection unit 109 switches the reference picture from the same-parity field to the temporally-closest referable field.

According to the present modification as described, the reference picture is selected on the basis of the smoothed SAD_AVE and the smoothed ACT_AVE. Unlike pulse noise, the smoothed SAD_AVE and the smoothed ACT_AVE do not show abrupt changes. Hence, the value of SAD_AVE/ACT_AVE does not abruptly change. This can prevent the reference picture from being frequently switched. In other words, the reference picture switching can be executed with stability. This reduces the dependence on a subject of video shooting, thereby reducing errors in the motion estimation. Accordingly, the coding processing can be performed without any decrease in the coding efficiency.

Note that when the N number of fields used for calculating the averages is larger, the reference picture switching can be more prevented from frequently occurring. However, when the N number is too large, a necessary reference picture switching may be delayed. On this account, N=4 or so is appropriate.

### Second Embodiment

Next, the second embodiment of the present invention is described. The present embodiment relates to a digital still camera or an image pickup system (i.e., a video system) like a network camera, which is implemented by using the image coding device 100 described in the first embodiment and the first and second modifications.

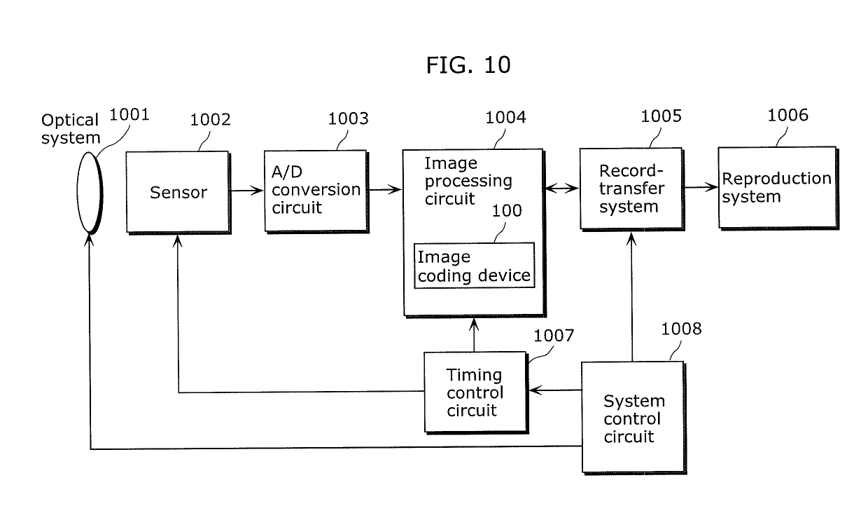

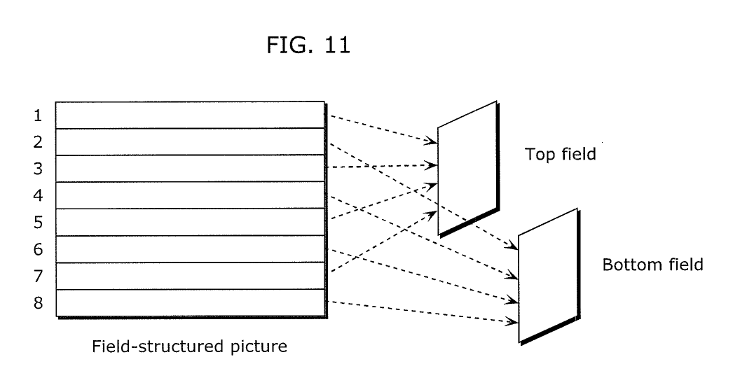

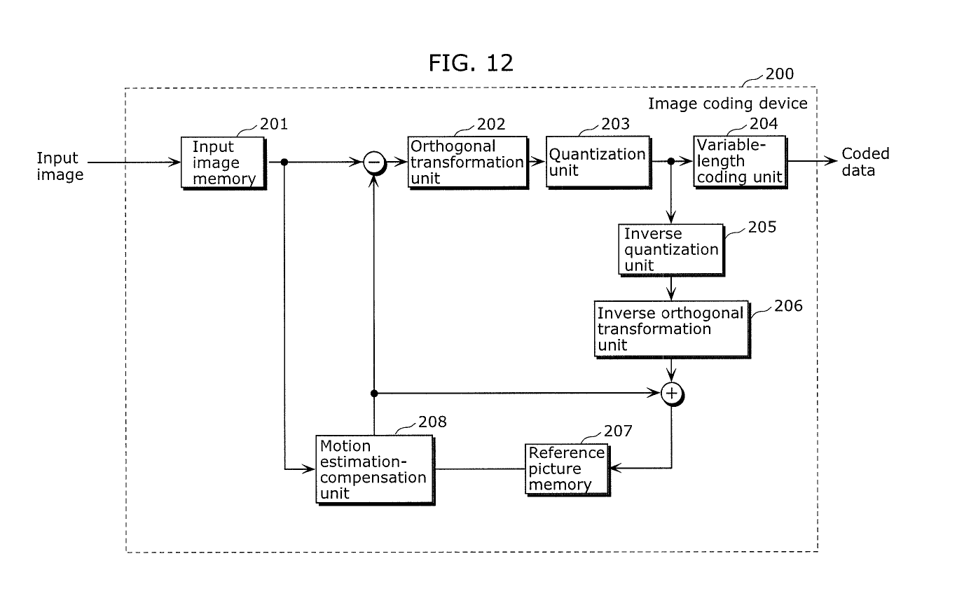

FIG. 10 is a block diagram showing a configuration of an image pickup system in the second embodiment.

The image pickup system includes an optical system 1001, a sensor 1002, an analog-to-digital (A/D) conversion circuit 1003, an image processing circuit (or, image processing unit) 1004, a record-transfer system 1005, a reproduction system 1006, a timing control circuit 1007, and a system control circuit 1008. The image processing circuit 1004 includes, for example, the image coding device 100 described in the first embodiment.

In this image pickup system, an image light passing through the optical system 1001 forms an optical image on the sensor 1002 which then performs photoelectric conversion on the optical image. An analog signal obtained by the photoelectric conversion is converted into a digital signal by the A/D conversion circuit 1003. After this, the digital signal is sent to the image processing circuit 1004. The image processing circuit 1004 performs: luminance/chrominance (Y/C) processing; edge treatment; image scaling processing; and image compression-decompression processing and compressed-stream control processing according to the H.264 standard or the like. Note that the image compression according to the H.264 standard or the like is performed using the image coding device 100.

The signal processed by the image processing circuit 1004 is recorded into a medium or transmitted via the Internet or the like by the record-transfer system 1005. The recorded or transmitted signal is reproduced by the reproduction system 1006. The sensor 1002 is controlled by the timing control circuit 1007. The optical system 1001, the record-transfer system 1005, the reproduction system 1006, and the timing control circuit 1007 are controlled by the system control circuit 1008.

As an example of the image pickup system shown in FIG. 10, a camera device has been described in which the sensor 1002 performs photoelectric conversion on the image light received from the optical system 1001 and the obtained signal is sent to the A/D conversion circuit 1003. However, the present invention is not limited to this. For example, an analog image received by an Audio/Visual (AV) device such as a TV may be directly sent to the A/D conversion circuit 1003.

Although the image coding device and the image coding method according to the present invention have been described on the basis of the above embodiments, the present invention is not limited to these embodiments.

In the above embodiments, the ACT is used as the predicted intra-coding amount and the SAD is used as the predicted inter-coding amount. However, values calculated by a different method may be used as long as the amount of coding required for the intra coding and the amount of coding required for the inter coding can be predicted.

In the above embodiments, a value obtained by dividing the predicted inter-coding amount by the predicted intra-coding amount is compared with the threshold to determine whether to perform the reference picture switching. However, a difference between the predicted inter-coding amount and the predicted intra-coding amount may be compared with a threshold to determine whether to perform the reference picture switching.

The image coding device 100 is implemented as a Large Scale Integration (LSI) which is typically an integrated circuit. The components of the image coding device may be integrated into individual chips or into one chip including some or all of the components. Although referred to as the LSI here, it may be referred to as an Integrated Circuit (IC), a system LSI, a super LSI, or an ultra LSI depending on the scale of integration.

A method for circuit integration is not limited to application of an LSI. It may be realized using a dedicated circuit or a general purpose processor. After an LSI is manufactured, a Field Programmable Gate Array (FPGA) which is programmable or a reconfigurable processor for which the connections and settings of circuit cells inside the LSI are reconfigurable may be used.

Moreover, when a circuit integration technology that replaces LSIs comes along owing to advances of the semiconductor technology or to a separate derivative technology, the function blocks should be understandably integrated using that technology.

Furthermore, the image coding device may be specifically a computer system configured with a microprocessor, a ROM, a RAM, a hard disk drive, a display unit, a keyboard, a mouse, and so forth. The RAM or the hard disk drive stores a computer program executed by the image coding device. The microprocessor operates according to the computer program, so that a function of the image coding device is carried out. Here, note that a computer program includes a plurality of instruction codes indicating instructions to be given to the computer so as to achieve a specific function.

Furthermore, the above embodiments and modifications may be combined.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

The image coding device and the image pickup system according to the present invention are capable of reducing the number of times a reference picture is accessed, reducing the amount of calculation required for motion estimation, and implementing coding with less image deterioration. Thus, the image coding device and the image pickup system are useful as a digital camera, a surveillance camera, and a network camera.

What is claimed is:

1. An image coding device which performs predictive coding on a moving image having a field structure, said image coding device comprising:
an inter-coding prediction unit configured to calculate a predicted inter-coding amount indicating a predicted amount of coding required to perform inter prediction on a coding-target field which is a target of predictive coding, when a reference picture is a same-parity field having a same parity as the coding-target field;
an intra-coding prediction unit configured to calculate a predicted intra-coding amount indicating a predicted amount of coding required to perform intra prediction on the coding-target field;
a reference picture selection unit configured to compare the predicted inter-coding amount and the predicted intra-coding amount, and to switch the reference picture from the same-parity field to a temporally-closest referable field which is referable and temporally closest to the coding-target field upon determining that the predicted inter-coding amount is relatively larger than the predicted intra-coding amount; and
a predictive coding unit configured to perform the predictive coding on the coding-target field using the reference picture.

2. The image coding device according to claim 1,
wherein said reference picture selection unit is configured to switch the reference picture from the same-parity field to the temporally-closest referable field, upon determining that a value obtained by dividing the predicted inter-coding amount by the predicted intra-coding amount is equal to or larger than a predetermined determination threshold.

3. The image coding device according to claim 2,
wherein (i) when the same-parity field is used as the reference picture, said reference picture selection unit is configured to switch the reference picture from the same-parity field to the temporally-closest referable field upon determining that the value obtained by dividing the predicted inter-coding amount by the predicted intra-coding amount is equal to or larger than a first determination threshold, and (ii) when the temporally-closest referable field is used as the reference picture, said reference picture selection unit is configured to switch the reference picture from the temporally-closest referable field to the same-parity field upon determining that the value obtained by dividing the predicted inter-coding amount by the predicted intra-coding amount is smaller than a second determination threshold which is smaller than the first determination threshold.

4. The image coding device according to claim 1, further comprising
a reference picture memory which stores, as reference picture candidates, two fields immediately preceding the coding-target field in order of reproduction, each of the reference picture candidates being one of an I-picture, a P-picture, and a referable B-picture,
wherein, when the predictive coding is performed on the coding-target field which is a P-picture, said reference picture selection unit is configured to compare the predicted inter-coding amount and the predicted intra-coding amount and to switch the reference picture from the same-parity field to the temporally-closest referable field upon determining that the predicted inter-coding amount is relatively larger than the predicted intra-coding amount, each of the same-parity field and the temporally-closest referable field being the reference picture candidate.

5. The image coding device according to claim 1, further comprising
a reference picture memory which stores, as reference picture candidates, two fields immediately preceding the coding-target field in order of reproduction and two fields immediately following the coding-target field in order of reproduction, each of the reference picture candidates being one of an I-picture, a P-picture, and a referable B-picture,
wherein, when the predictive coding is performed on the coding-target field which is a B-picture, said reference picture selection unit is configured to compare the predicted inter-coding amount and the predicted intra-coding amount and, upon determining that the predicted inter-coding amount is relatively larger than the predicted intra-coding amount, to select, as the reference pictures from among the reference picture candidates, the temporally-closest referable field out of the two immediately preceding fields and the temporally-closest referable field out of the two immediately following fields.

6. The image coding device according to claim 1,
wherein said inter-coding prediction unit is configured to
firstly calculate an absolute difference in luminance between each pixel in each of macroblocks included in the coding-target field and a corresponding pixel in a corresponding macroblock included in the reference picture,
secondly sum the calculated differences for each of the macroblocks, and
finally sum the summed differences of the macroblocks to obtain a sum of absolute differences as the predicted inter-coding amount of the coding-target field.

7. The image coding device according to claim 1,
wherein said intra-coding prediction unit is configured to
firstly calculate an absolute difference between a luminance value of each pixel in each of macroblocks included in the coding-target field and an average luminance value of the macroblock,
secondly sum the calculated differences for each of the macroblocks, and
finally sum the summed differences of the macroblocks to obtain a sum of absolute differences as the predicted intra-coding amount of the coding-target field.

8. The image coding device according to claim 1,
wherein said reference picture selection unit is configured to smooth the predicted inter-coding amount and the predicted intra-coding amount in a direction of time to compare the smoothed predicted inter-coding amount and the smoothed predicted intra-coding amount, and to switch the reference picture from the same-parity field to the temporally-closest referable field upon determining that the smoothed predicted inter-coding amount is relatively larger than the smoothed predicted intra-coding amount.

9. An image coding method used by a computer performing predictive coding on a moving image having a field structure, said image coding method comprising:
calculating, by the computer, a predicted inter-coding amount indicating a predicted amount of coding required to perform inter prediction on a coding-target field which is a target of predictive coding, when a reference picture is a same-parity field having a same parity as the coding-target field;
calculating, by the computer, a predicted intra-coding amount indicating a predicted amount of coding required to perform intra prediction on the coding-target field;
comparing, by the computer, the predicted inter-coding amount and the predicted intra-coding amount, and switching the reference picture from the same-parity field to a temporally-closest referable field which is referable and temporally closest to the coding-target field upon determining that the predicted inter-coding amount is relatively larger than the predicted intra-coding amount,; and
performing, by the computer, the predictive coding on the coding-target field using the reference picture.

10. A non-transitory computer-readable recording medium having recorded thereon a computer program for performing predictive coding on a moving image having a field structure, the computer program, when loaded onto a computer, causing the computer to execute:
calculating a predicted inter-coding amount indicating a predicted amount of coding required to perform inter prediction on a coding-target field which is a target of predictive coding, when a reference picture is a same-parity field having a same parity as the coding-target field;
calculating a predicted intra-coding amount indicating a predicted amount of coding required to perform intra prediction on the coding-target field;
comparing the predicted inter-coding amount and the predicted intra-coding amount, and switching the reference picture from the same-parity field to a temporally-closest referable field which is referable and temporally closest to the coding-target field upon determining that the predicted inter-coding amount is relatively larger than the predicted intra-coding amount,; and
performing the predictive coding on the coding-target field using the reference picture.

11. An image pickup system comprising:
an optical system which receives light and forms an optical image from the light;
a sensor which receives the optical image formed by said optical system and converts the optical image into an image signal; and
the image coding device which receives the image signal as the moving image, according to claim 1.
